(19) United States
(12) Patent Application Publication
(10) Pub. No.: US 2009/0136794 A1
(43) Pub. Date: May 28, 2009

(54) DIRECT OXIDATION FUEL CELL FOR THE CONVECTION-FREE TRANSPORT OF FUEL AND METHOD FOR OPERATING THE FUEL CELL

(76) Inventor: Steffen Eccarius, Freiburg (DE)

Correspondence Address: GAUTHIER & CONNORS, LLP, 225 FRANKLIN STREET, SUITE 2300, BOSTON, MA, 02110, US

(21) Appl. No.: 12/335,029

(22) Filed: Dec. 15, 2008

Related U.S. Application Data
(63) Continuation of application No. PCT/EP2007/005608, filed on Jun. 25, 2007.

(30) Foreign Application Priority Data
Jun. 30, 2006 (DE) 102006030236.2

(51) Int. Cl. H01M 8/04; H01M 2/02; H01M 8/10

(52) U.S. Cl. 429/13; 429/34; 429/30

(57) ABSTRACT

The present invention relates to a direct oxidation fuel cell for the convection-free transport of at least one fuel and also to a method for operating the direct oxidation fuel cell. The principle according to the invention is hereby based on transport of the fluidic fuel from the fuel reservoir to a membrane electrode unit, the transport being effected through a capillary structure using capillary forces and an evaporation suction.

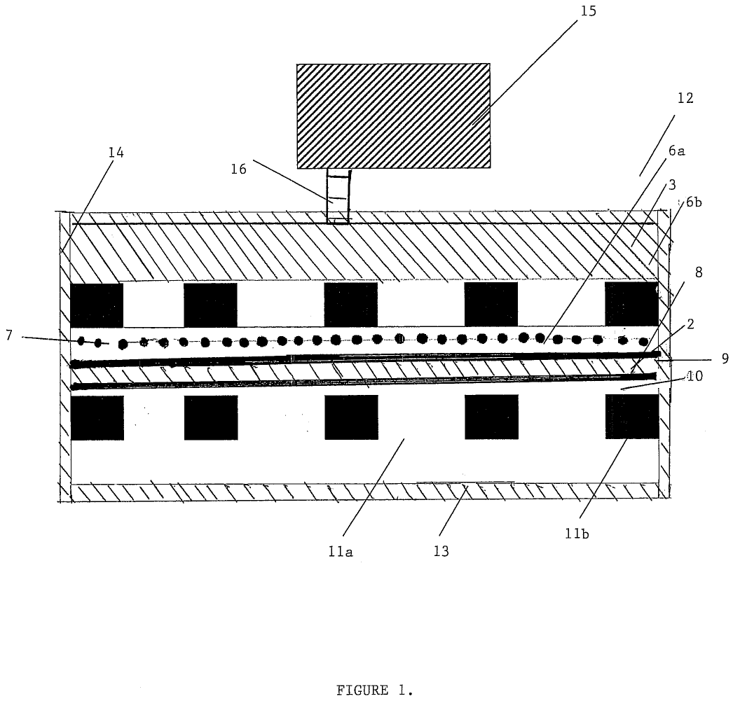

### PRIORITY INFORMATION

The present application is a continuation of International Application No. PCT/EP2007/005608, filed on Jun. 25, 2007, that claims priority to German Application No. DE 102006030236.2, filed on Jun. 30, 2006, both of which are incorporated herein by reference in their entireties.

### BACKGROUND OF THE INVENTION

The invention relates to a direct oxidation fuel cell for the convection-free transport at least of one fuel and also to a method for operating the direct oxidation fuel cell. The principle according to the invention is hereby based on transport of the fluidic fuel from the fuel reservoir to a membrane electrode unit, the transport being effected through a capillary structure using capillary forces and evaporation suction.

Current energy stores for portable electronics are suitable for numerous applications only with restrictions since the achievable running times are not satisfactory. Fuel cells offer a significant improvement potential since the chemical stores, essentially: methanol and hydrogen, have very high energy densities.

In the case of portable applications, the main problem resides in the storage of hydrogen which does not have high storage densities both gravimetrically and volumetrically. In addition, the handling of gaseous fuels is difficult in comparison with liquid fuels. Liquid fuels, e.g. methanol, have however, on the other hand, the problem of a complex system technology in order to fulfill the functionalities in application, i.e. supply of fuel, adjustment of the concentration etc.

Continuous supply of the fuel cell with a liquid fuel/water mixture which is supplied as a rule with the help of a pump is the state of the art. The cathode is subjected to a forced flow generally with air or oxygen even though self-breathing concepts are also known (Chen, C. et al., Journal of Power Sources 123 (2003) 37 -42).

There are merely very occasional reports in the literature relating to the concept of supplying methanol in the vapour phase (J. Kallo et al., Journal of Power Sources 127 (2004), 181-186; KaIlo et al., Journal of the Electrochemical Society, 150 (6) A7765 -A769 (2003); A. K. Shukla et al., Journal of Power Sources 55 (1995) 87 91; M. Hogarth et al., Journal of Power Sources 69 (1997) 125-136). The authors deal thereby in a detailed manner with the described advantages of the vapour operation. In general actively heated evaporators are used. A direct oxidation fuel cell system which uses an anode-side supply of the reactands from the gas phase, instead of a liquid fuel or fuel/water mixture, has a series of theoretical advantages:
The kinetics of transporting the reactands to the active surfaces of the electrode is significantly improved since the diffusion coefficients of the species in gas phases are very much greater than in liquids.
The transport away of the reaction product carbon dioxide is problematic in the operation of a conventional DMFC supplied from a liquid phase since the gas bubbles in a corresponding two phase system do not have adequate mobility. In a vapour supplied direct methanol fuel cell (DMFC), in which reaction educts and products on the anode side are present in the same phase, the CO transport away turns out to be significantly more effective (J. Kallo et al., Cell Voltage Transient of a Gas-fed Direct Methanol Fuel Cell, Journal of Power Sources 127 (2004), 181-186).
In addition to losses which are caused by a comparatively low activity of the anode catalyst, losses occur in addition in the DMFC due to the passage of methanol to the cathode (“crossover”). In addition to fuel losses, the result in addition is a drop in the cathode potential. It was reported for a vapour-operated cell (Kallo et al., Conductance and Methanol Crossover Investigation of Nafion Membranes in a Vapor-fed DMFC, Journal of the Electrochemical Society, 150 (6) (2003), A765-A769) that, relative to a liquid phase-supplied cell, the crossover can be reduced by up to 50%, which has significant advantages for the performance data of the fuel cell system.
Building hereon, the concentration of the methanol in the mixture can be significantly increased, which leads to better performance data and to a simpler system technology.
The temperature on the anode increases since it is not cooled constantly with a liquid methanol flow. Higher temperatures involve greatly improved methanol oxidation kinetics.

### SUMMARY OF THE INVENTION

Previous reports on vapour-operated DMFC generally focus on systems which use an actively heated evaporator. The advantages of the vapour operation are extensively negated in this approach by the disadvantage of a more complex system periphery so that the vapour concept has not yet to date been able to be realised.

Transfer of the vapour concept to passive, i.e. non-actively heated evaporators, in conjunction with planar fuel cells is to date not known from the state of the art.

Starting from these disadvantages of the state of the art, it was the object of the present invention to enable a complete passive supply of the anode chamber of fuel cells with a fluidic fuel. This object is achieved by the direct oxidation fuel cell having the features of claim 1 and the method for operating a direct oxidation fuel cell having the features of claim 26. The further dependent claims reveal advantageous developments.

According to the invention, a direct oxidation fuel cell for the convection-free transport of at least one fluidic fuel is provided, which comprises a membrane electrode unit with anode and cathode, at least one fluid distribution structure and also at least one fuel reservoir. A capillary structure which connects the membrane electrode unit to the at least one fuel reservoir is essential to the invention. The capillary structure according to the invention is thereby provided for the transport of fuel, the transport being caused by capillary forces and also an evaporation suction.

The capillary forces represent a physical property which enables the transport of liquids and substances contained therein within ultrafine capillary pipes, pores or gaps in all directions, i.e. even opposite to the force of gravity. In contrast to lines with a larger cross-section, the transport of wetting liquids can be effected without pumps and hence without additional energy. The conveying level and conveying quantity are thereby dependent upon various factors. There are included herein the adhesion force of the materials, the size, number and length of the capillaries, the wetting capacity of the liquid, the effect of gravity and also the suction and pressure effect, such as e.g. with evaporation suction.

The principle of the passive transport of fuel according to the invention is intended to be clarified with reference to the following example. Thus a capillary structure with a multiplicity of ultrafine glass fibres is wetted on one side with fuel. After discharge of the air from the capillary structure, the fuel can pass from the reservoir to the anode. The underlying driving force for the transport in the capillary structure is, in addition to the capillary force, a so-called evaporation suction. The fuel is consumed in the anode chamber so that the partial pressure gradient from the reservoir to the anode chamber ensures subsequent evaporation of the fuel in the anode chamber. The apex of the capillary structure is depleted thus in fuel with the consequence that new fuel is subsequently supplied from the reservoir. The evaporation suction at the apex of the capillary structure is assisted in addition by higher temperatures in the anode chamber.

According to the requirement of the consumer on the fuel cell, different flows and hence also different quantities of fuel are required. In the case of the capillary structure according to the invention, the fuel flow can be adapted via number, length and size of the capillaries, corresponding to the requirements of the consumer.

Preferably the capillary structure has a plurality of capillaries which are disposed essentially parallel to each other. In a preferred embodiment, hollow glass fibres are used as capillaries. A further preferred variant provides that a plurality of capillary structures is woven in the form of a braided material in a parallel orientation relative to each other. A braided material or mat of this type has the advantage that a greater capillary action in the fibre direction in comparison with chaotically interlaced fibres can be achieved by the directed fibres,

Furthermore, it is preferred that the fuel reservoir is covered at least partially with such a braided material. In particular the wall of the fuel reservoir is hereby covered with braided materials of this type. This enables an operation of the reservoir which is independent of position and almost independent of level.

A further preferred variant provides that the at least one capillary structure has a gas-tight covering. With this, fuel losses between reservoir and apex of the capillary structure can be reduced or entirely prevented. Preferably, the gas-tight covering consists of a material selected from the group comprising polyethylene, polypropylene, polymethylpentene, polyoxymethylene and ethylene propylene diene copolymer.

A further preferred embodiment provides that the individual capillaries of the at least one capillary structure fan out in the anode-side fluid distribution structure into individual glass fibres and are distributed on the surface. The anode-side gas diffusion layer is thereby equipped preferably hydrophobically in order to prevent wetting of the electrode with liquid fuel. In the mentioned embodiment, a unit comprising capillary structure and gas diffusion layer is hence present.

Due to the thermodynamics of the evaporation process, it can be achieved, by including a suitable, likewise passive use of the product water, that a self-regulating system is produced: the aim of the mentioned system of producing the saturation partial pressure for the fuel in the gas chamber of the anode offers the thermodynamic basis in this respect. If a lot of fuel is converted, a high temperature which is caused by fuel cell losses prevails and effects an evaporation suction. As a result, more fuel is subsequently supplied. If no fuel is converted, the temperature drops and the saturation partial pressure is adjusted. Finally, the evaporation suction comes to a standstill at thermodynamic equilibrium.

On the anode side of the fuel cell, the fuel is usually oxidised to form protons and electrons with the assistance of water. On the cathode side of the fuel cell, the protons are reduced to water with the help of atmospheric oxygen. In the case of many fuels, more water is produced hereby at the cathode than is consumed at the anode. If, in contrast to the state of the art, there are used for liquid fuels thin ionomers (<100 μm) for the membrane electrode units (MEA), the reverse diffusion of the water from the cathode can also be used with suitable geometric design and highly concentrated fuel can be guided towards the anode. In addition, this includes the advantage that less water needs to be emitted to the ambient air in the case of self-breathing cells. As a result, the temperature range in which the fuel cell can operate is extended.

A further preferred embodiment provides that the capillary structure is metallised in the partial region which abuts against the anode chamber of the fuel cell. A metallisation of copper with subsequent passivation with nickel/gold or similar metals is hereby preferred. The externally situated metal should hereby ensure a low contact resistance. In the case of a sufficiently low specific resistance of the composite, preferably <50 mΩm, a standard fluid distribution structure on the anode can be entirely dispensed with and the flow can be diverted directly. The capillary transport of the fuel is preferably configured in such a manner that wetting of the electrode with liquid fuel does not tale place, e.g. due to very small transport quantities.

It is preferred in addition that the metallised capillary structure is integrated in the anode, dispensing with an anode-side gas diffusion layer. Hence the layer thicknesses (electrode approx. 10 μm, gas diffusion layer approx. 200 μm and fibre approx. 200 μm) can be significantly reduced again, preferably to approx. 100 μm, so that the fuel cell becomes thinner and the volumetric and also gravimetric power densities increase significantly or a simple housing application becomes possible. Since the kinetics in the vapour operation are significantly faster, the noble metal content of the anode- or even of the cathode catalyst can also be lowered, which leads to a further reduction in layer thickness just as the cost. Whilst the noble metal content according to the state of the art is approx. 2 mg/cm², the system according to the invention enables contents of less than 0.5 mg/cm^{2.}

Furthermore, it is preferred that the fuel cell has in addition a device for removing gaseous reaction products of the liquid fuel. There are included herein for example the removal of the resulting CO₂ on the anode side. The CO₂ can emerge in a preferred variant through an opening into the ambient air. The problem of the continuous diffusive loss of the fuel can thereby occur. The opening should therefore preferably be incorporated at one end of a channel so that the highly concentrated fuel has depleted extensively at the catalyst of the membrane electrode unit.

A further solution to this problem resides in the fact that a pressure valve is incorporated. This is preferably disposed at the end of the above-mentioned channel. With a specific excess pressure in the system, the pressure valve opens briefly, ensures pressure equalisation with the environment and depletes the channel again of CO₂.

A further preferred variant provides that the fuel is depleted as far as possible on the anode side via the catalyst and is guided over a further oxidation path, e.g. a pipe with a catalyst, which is open relative to the ambient air. The oxidation effected by the catalyst leads to the fact that no fuel can escape into the ambient air. Furthermore, the combustion energy can be used in order to heat the anode chamber and consequently to increase the kinetics of the oxidation reaction or even the evaporation rate of the fuel. A further preferred variant provides that the supply of fuel via the capillaries can be interrupted. Mechanical variants are conceivable here, such as withdrawing the capillary structure, pinching the capillary structure or even interrupting the capillary structure by moving otherwise touching capillary structures.

According to the invention, a method is likewise provided for operating a direct oxidation fuel cell, in which at least one fluidic fuel is transported from at least one fuel reservoir to a membrane electrode unit. The transport of the at least one fluidic fuel is thereby effected through at least one capillary structure using capillary forces and an evaporation suction. The transport is hence convection-free.

The subject according to the invention is intended to be explained in more detail with reference to the subsequent FIGURE without wishing to restrict said subject to the special embodiment shown here.

### DETAILED DESCRIPTION OF THE ILLUSTRATED EMBODIMENT

The FIGURE shows a variant according to the invention of the direct oxidation fuel cell described here, which enables a convection-free transport of the fuel.

The FIGURE shows a first direct methanol fuel cell 1 according to the invention in cross-section. The DMFC has the shape of a rectangle with an edge length of 8 cm×4 cm and height of 1.5 cm. The DMFC 1 is constructed in layers in the z axis. It is subdivided into a cathode unit and an anode unit which are separated by a proton-conducting membrane 2.

The anode unit itself is subdivided into a reservoir chamber 3 and all anode chamber.

The anode chamber comprises a flow field 6 and a gas diffusion layer 7. The flow field 6 abuts against the reservoir chamber 3, the gas diffusion layer 7 abuts, on the anode side, against the proton-conducting membrane 2.

The flow field 6 is configured as a parallel channel structure comprising gold-plated stainless steel. The channels extend in the z direction from the reservoir chamber 3 to the gas diffusion layer 7. The gas is distributed homogeneously through the flow field 6 and conducted towards the gas diffusion layer 7.

The voltage applied during operation of the DMFC is tapped via the flow field 6. For this reason, the flow field 6 is subdivided into two regions: into a flow field intermediate space 6a and a current collector region 6b. The current collector 6b contacts the gas diffusion layer electrically.

The gas diffusion layer 7 comprises a carbon fibre nonwoven. It is highly porous, as a result of which effective transport to and away of the reactands is achieved. In addition, the gas diffusion layer 7 is electrically conductive. By means of the large number of fine carbon fibres, the gas diffusion layer 7 can contact the anode homogeneously at closely adjacent contact points.

The cathode unit of the DMFC 1 has an analogous layer construction to the anode unit: a gas diffusion layer 10 abuts on the cathode side against the proton-conducting membrane 2. The nearest layer is a flow field 11. Gas diffusion layer 10 and flow field 11 form the cathode unit.

The DMFC 1 is sealed on the anode side by an end plate 12. Also on the cathode side there is located an end plate 13 which seals the DMFC 1 on this side. The cathode-side end plate 13 is partially perforated. This ensures the supply of oxygen during operation of the cell.

The outer edge of the cuboid DMFC 1 is sealed by a cell housing 14.

On the cell housing 14, a pressure relief valve, not illustrated here, can be applied in the region of the flow field 6. The pressure relief valve opens at a pressure of 2 bar in order to release any carbon dioxide produced in the anode chamber to the environment.

Furthermore, the DMFC contains a tank 15. The tank 15 serves to receive the methanol or the methanol-water mixture. The tank 15 is connected to the reservoir chamber 3 via a capillary structure for transport of the fuel 16.

The proton-conducting membrane 2 comprises sulphonated polymers. Furthermore, the membrane 2 is coated on the anode side with a catalyst 8 made of platinum-ruthenium (atomic ratio 50-50) and, on the cathode side, with a catalyst 9 made of platinum. Catalyst 8 and catalyst 9 are porous in order to have as large a surface as possible.

The reservoir chamber 3 is filled by an absorbent structure 5. A variant according to the invention is based on the individual capillaries of the capillary structure 16 fanning into the reservoir chamber 3.

The DMFC 1 according to the invention can be operated with pure methanol or a methanol-water mixture.

The methanol-water mixture for example is filled into the tank 15 for the operation. Because of the suction effect of the supply pipe 6 and the absorbent structure 5, the mixture is suctioned from the tank 15 via the supply pipe 16 into the reservoir chamber 3 and distributed in the latter.

The gas evaporating from the methanol mixture passes into the flow field 6. The gas is distributed homogeneously via the gas diffusion layer 7 by the flow field 6.

Finally, the gas passes to the anode, i.e. to the anode-side catalyst layer 8 of the membrane 2.

On the cathode side, oxygen passes from the environment of the DMFC 1 through the cathode-side perforated end plate 13 to the cathode-side catalyst layer 9 of the membrane.

Carbon dioxide is produced on the anode side and water on the cathode side in the following reactions. The carbon dioxide which would restrict the operation of the cell in the case of too high a proportion is released to the environment by the pressure relief valve. The water is absorbed by the ambient air.

The described process runs as long as the methanol mixture can be suctioned into the reservoir chamber 3. Hence a continuous operation of the DMFC 1 is possible.

In particular, the process takes place completely automatically: no external, active means, such as for example pumps, which convey the methanol mixture are required in order to maintain the operation of the cell. Such a cell can have a small and compact configuration so that the latter is possible in particular as a battery replacement.

As an alternative, flow field 6 and 11 and diffusion layer 7 and 10 can be replaced by microstructured flow fields. These microstructures combine the properties of the gas diffusion layer and of the flow field.

In a further alternative embodiment, the anode unit is provided with a heating element. With this heating element, the evaporation rate of the methanol or of the methanol-water mixture can be regulated. Consequently, the output power of the DMFC can be controlled, in particular, stabilised.

The gaseous methanol flow from the reservoir chamber 3 into the anode chamber and hence to the reaction surface of the anode can be varied in general by suitable geometric structures and adapted for the respective application. For example, this can be achieved by the arrangement of the current collectors of the flow field 6b (height or width of the webs, size of the intermediate spaces), the thickness of the gas diffusion layer 7 or the geometry of the micro structured flow field (opening ratio etc.). By means of suitable constructive measures, the methanol flow can be adjusted such that the methanol is oxidised extensively completely at the anode. Ideally, only as much methanol is hence supplied to the anode as is actually consumed by the electrochemical oxidation reaction. Hence methanol crossover and the losses associated therewith are essentially avoided. The water required in particular during an operation with almost pure methanol at the anode passes from the cathode by diffusion through the membrane 2 to the anode. In this respect, an operation with highly concentrated methanol is possible, the advantage of the high energy density of the methanol can be exploited.

What is claimed is:

1. A direct oxidation fuel cell for the convection-free transport of at least one fluidic fuel comprising a membrane electrode unit with anode and cathode, at least one fluid distribution structure and also at least one fuel reservoir, wherein
the fuel cell has at least one capillary structure which connects the membrane electrode unit to the at least one fuel reservoir for the transport of the fuel by means of evaporation suction.

2. The direct oxidation fuel cell according to claim 1,
wherein the capillary structure has a plurality of capillaries which are disposed essentially parallel to each other.

3. The direct oxidation fuel cell according to claim 2, wherein the capillaries are hollow glass fibres.

4. The direct oxidation fuel cell according to claim 1, wherein a plurality of capillary structures is woven in the form of a braided material in a parallel orientation relative to each other.

5. The direct oxidation fuel cell according to claim 4, wherein the fuel reservoir is covered at least partially with the braided material.

6. The direct oxidation fuel cell according to claim 1, wherein the at least one capillary structure has a gas-tight covering.

7. The direct oxidation fuel cell according to claim 6, wherein the covering consists of a material selected from the group consisting of polyethylene, polypropylene, polymethylpentene, polyoxymethylene and ethylene propylene diene copolymer.

8. The direct oxidation fuel cell according to claim 1, wherein the individual capillaries of the at least one capillary structure fan out in the anode-side fluid distribution structure.

9. The direct oxidation fuel cell according to claim 1, wherein at least one heating wire is disposed in the at least one capillary structure for temperature control of the capillaries and regulation of the evaporation rate.

10. The direct oxidation fuel cell according to claim 9, wherein the heating wire is fed with current released via the fuel cell.

11. The direct oxidation fuel cell according to claim 1, wherein the membrane electrode unit consists of a proton-conducting membrane and also, respectively on the anode side and cathode side, catalyst layers and gas diffusion layers or microstructures.

12. The direct oxidation fuel cell according to claim 11, wherein the anode-side gas diffusion layer is equipped hydrophobically.

13. The direct oxidation fuel cell according to claim 11, wherein the proton-conducting membrane is impermeable for the fuel and the reaction products.

14. The direct oxidation fuel cell according to 11, wherein the proton-conducting membrane consists of an ionomer.

15. The direct oxidation fuel cell according to claim 11, wherein the proton-conducting membrane has a thickness of ≦100 μm.

16. The direct oxidation fuel cell according to claim 10, wherein the catalyst layers comprise platinum, ruthenium and/or alloys thereof.

17. The direct oxidation fuel cell according to claim 10, wherein the catalyst layers comprise platinum, tin and/or alloys thereof.

18. The direct oxidation fuel cell according to claim 10, wherein the noble metal content of the anode-side catalyst layer is in the range of 0.2 to 1 mg/cm².

19. The direct oxidation fuel cell according to one claim 1, wherein at least one capillary structure is metallised on the end thereof which points towards the membrane electrode unit.

20. The direct oxidation fuel cell according to the preceding claim, wherein the metallisation has a specific resistance ≦50 mΩm.

21. The direct oxidation fuel cell according to the preceding claim, wherein the metallisation consists of a corrosion-resistant metal or an alloy.

22. The direct oxidation fuel cell according to claim 19, wherein the metallised end has in addition a passivation layer, in particular made of nickel or gold.

23. The direct oxidation fuel cell according to claim 19, wherein the metallised capillary structure is integrated in the anode, dispensing with the anode-side gas diffusion layer.

24. The direct oxidation fuel cell according to claim 1, wherein the fuel cell has in addition a device for removing gaseous reaction products.

25. The direct oxidation fuel cell according to claim 24, wherein the device for removing gaseous reaction products is a pressure relief valve.

26. A method for operating a direct oxidation fuel cell, in which at least one fluidic fuel is transported from at least one fuel reservoir to a membrane electrode unit, wherein the transport of the at least one fluidic fuel is effected in a convection-free manner through at least one capillary structure using capillary forces and an evaporation suction.

27. The method according to claim 26, wherein capillaries of different lengths are used.

28. The method according to claim 26, wherein the transport of the fuel is controlled via the number, length and size of the capillaries in the capillary structure.

29. The method according to claim 26, wherein the transport is controlled thermodynamically by the evaporation of the fuel and the adjustment of the saturation partial pressure of the fuel in the fuel cell.

30. The method according to claim 26, wherein methanol is used as fuel.

31. The method according to claim 26, wherein ethanol is used as fuel.

32. The method according to claim 26, wherein gaseous reaction products are separated from the at least one liquid fuel in the fuel cell.

33. The method according claim 32, wherein gaseous reaction products and fuel are discharged via an opening and conducted over a catalyst in order to oxidise these for the generation of heat.
